(19) United States
(12) Patent Application Publication
(10) Pub. No.: US 2019/0164140 A1
(43) Pub. Date: May 30, 2019

(54) SYSTEM AND METHOD FOR BLOCKCHAIN BASED CONTENT MONETIZATION IN AN ONLINE TRADING PLATFORM

(71) Applicant: Ramya Pasupula, Brisbane (AU)

(72) Inventor: Ramya Pasupula, Brisbane (AU)

(21) Appl. No.: 15/822,105

(22) Filed: Nov. 24, 2017

(51) Int. Cl. G06Q 20/12; G06F 17/30; G06Q 20/38; G06Q 30/08; G06Q 30/06; G06Q 30/02

(52) U.S. Cl. CPC G06Q 20/123; G06F 17/30283; G06Q 20/3829; G06Q 2220/00; G06Q 20/3827; G06Q 30/0609; G06Q 30/0282; G06Q 30/08

(57) ABSTRACT

A system and method for blockchain based content monetization in an online trading platform is disclosed. The system comprises a user layer, an application layer, an access layer, a database layer. Said layers are communicatively coupled with each other, configured to evaluate strength of the bids and shortlisting bids of the vendors in an online trading platform. The shortlisted bids are displayed to the content creators. The strength of the bids and shortlisting bids of the vendors is based on utilizing blockchain and a hashed universally unique identifier (UUID) authenticated vendor rating system. The layers in the system is configured to assist in decision-making process for the content creators to decide on which bids to accept or decline. The system further analyzes the bid based on one or more monetary aspects and one or more non-monetary aspects such as location of the vendor and content creators.

### BACKGROUND OF THE INVENTION

### A. Technical Field

The present invention generally relates to blockchain based content monetization in an online marketplace or trading platform. More specifically, this invention relates to a system incorporated with blockchain in context to the process of content monetization benefitting the content creator and vendors in the online trading platform.

### B. Description of Related Art

Traditionally, context information is always stored or shared in the form of textual entities, however in today's digital era, content is stored in digital format. Online content is defined as anything that can be digitized and delivered from creator to audiences over the internet. This might include text, image, video and other forms of representation of data or information. Many traditional industries including books, newspaper, magazine publishers, software companies, artists, video training companies are moving their content online. The web speeds up development, reaches to global audience and most importantly strips out costs. For example, the cost of a typical book includes paying for design, typesetting, printing, agent fees, publisher charges, wholesaler margin, retailer margin and distribution. On the internet, a writer can format their own document and access global market with zero distribution costs.

‘Monetization’ can be defined as the conversion of an anything (tangible and intangible) into money or legal ledger. The term “monetize” is context specific and its meaning varies according to the context. In the course of this document, the word Monetization will refer to the process of generating money from online content. Content Monetization can be explained as ‘The process of actively making money from content that generally exists on a website, an app or anything in between.’ Most of the companies have utilized the internet to monetize their content. For utilizing internet two most likely approaches are adopted by companies. The first approach is to sell their content and second approach is to make the content freely available depending upon the advertising for returns. The decision for adopting one of the above models, is influenced by the industry segments.

There are two major ways for content monetizing that drives return on investment (ROI). One way driven by marketing-influenced revenue, through content marketing, by increasing leads, conversions, and upsell/cross-sell revenue. Another way driven by increasing brand equity, where effective content marketing programs increase a brand's awareness, loyalty, and value. Nowadays, the content creators have two huge advantages that they did not have a decade ago in getting consumers to pay for content. Firstly, they have customers who are far more technically literate and accustomed to sophisticated websites with complex business models. These customers are also familiar with content offerings from various industries that have been successful in monetizing their content. Secondly, the tools and technology components can streamline and improve the overall effectiveness of digital content creation and monetization processes.

An existing prior art, U.S. patent application Ser. No. 15/418,509 of Kohn, discloses a variety of improved techniques including payment systems that utilize encrypted computer networking (ECN) to provide industrial transparency, rapid accounting and payment, end-to-end credibility inspiring user confidence and assurance for the monetization, payment processing, and royalty distribution of copyrights, content, services and agreements. Components of the disclosed payment system run on ECN, such as the Blockchain, as a backend to process payments. Further, in another prior art, U.S. patent application Ser. No. 11/670,713 of Starr et al. discloses an advertisement revenue sharing for distributed video. The video distribution method modifies video to incorporate a tag that associates the video with an advertisement and facilitates payment of a share of advertising revenue to an owner of the video when the video and/or its associated advertisement are displayed at a client device.

Further, in another prior art, U.S. patent application Ser. No. 14/283,169 of Puertolas-Montaries, et al. discloses a system and method for providing personal computing and service provider platforms for enabling a consumer to control and monetize their personal data while managing their online privacy. Business methods utilizing the systems and methods of the present invention resemble those of profit-sharing and asset-sharing paradigms such as cooperatives, and they comprise means for enabling a diverse array of individual subscriber shareholders to receive dividends, share profits and assets, pool resources, and otherwise participate in the ownership of the personal and behavioral data and other content that they generate.

An online publication titled “Blockchain in Digital Advertising” by DigitalAdBlog discloses implementation of blockchain in digital advertising and media industry. AdChain is an open protocol on Ethereum public blockchain. Advertisers and publishers can create their applications which can leave a campaign trail, allowing them to obtain first party data ownership. Some of the long-term impacts and uses in advertising and media which will allow users to pay for someone's attention directly include: Monetization: letting writers get immediately paid for the content they distribute to amongst their audience. For example, an Adblock browser which users use to pay publishers to access their site content using cryptocurrency.

General industry standards and research indicate that the industries are adopting content marketing and product advertisement for promoting their services. However, these methodologies are not sufficient to ensure that the consumer stumbles upon the relevant products or services. Existing arts lack in a blockchain based content monetization solution for evaluating strength of the bids and shortlisting bids of the vendors in an online market platform that could be present to the content creators. The existing system also lacks in evaluating strength of the bids and shortlisting bids by including blockchain based genuine vendors rating system. Existing arts further lacks in analyzing bid based on monetary aspects, and non-monetary aspects.

Accordingly, there exists a need for an improved system and method for enabling blockchain based content monetization using vendor ratings. There is also a need for a system and method, which provides an ability on decision-making process for the content creators to decide on which bids to accept or decline. Further, there is a need for a system analyzing the bid based on monetary aspects and non-monetary aspects such as, location of the bidder/vendor and content creators.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention generally relates to system and method for blockchain based content monetization in an online trading platform. A system for blockchain based content monetization in an online trading platform. The system comprises one or more layers, such as, a user layer, an application layer, an access layer and a database layer, which are communicatively operated with each other, to provide an improved content monetization operation by presenting genuine vendor ratings to a content creator which enable decision-making process in an online trading platform.

The user layer includes a website browser module, a content section module, a vendor module and a buyer module. The website browser module (hardware device functions for “Website Browers”) configured to allow one or more type of users including a vendor, a buyer, a content creator, access a commerce portal, a content portal and a community portal (in the single online trading platform), on registering in the online trading platform. Herein, each type of users is generated with a hash key, a pair of public key and private key, wherein the generated public key is stored with the data on the blockchain and the private key is shared with the users.

The content section module (hardware device functions for “Content Creators”) enables content creators to create and post one or more contents in the platform. The content section module is configured to receive one or more biddings for one or more posted contents from the vendors. The vendor module (hardware device functions for “Vendors”) enables one or more vendors to sell goods and services or create own e-store in the platform. The buyer module (hardware device functions for “Buyers”) enables one or more buyers to buy goods and services from the vendors in the platform.

The application layer includes a decentralized application and an application programming interface. The decentralized application includes a back-end application programming interface and a front-end application programming interface or a user interface. The application programming interface (API) comprises a blockchain API, database API, APIs for frontend and APIs for smart contracts, is incorporated for internal and external communication between the layers.

The access layer is a smart contract comprise one or more rules, business logic and conditions, wherein the access layer include an identity management module (hardware device functions for “Identity Management”), a verification of proposal module (hardware device functions for “verification of proposal/Bid”), and a transaction management module (hardware device functions for “transaction management/Payment”).

The identity management module is configured to identify one or more users including website browser, content creators, vendors and buyers. The verification of proposal module performs verification of vendors bidding by tag matching, wherein the tag matching is done by comparing tags defined by both vendor and content creator. The verification of proposal module performs rating classification based on a buyer rating on the vendors. The system further uses genuine vendor ratings as one of the input parameters to provide bid/proposal and overall value that enables the system to rank the bids in the order of 1 to n. Said bids are displayed to the content creator, where the system provides an option for the content creator to sort out predetermined number of bids or pre-selected bids, for example, the content creator may have received n=200 bids but the content creator opt to review only top 5 bids, so the algorithm incorporated in the system does the necessary calculations, ranks all the bids, and displays only those number of bids that the content creator nominates to review.

The verification of proposal module performs filtration process by one or more parameters including location, acceptance ratio, or commission, to pre-process the proposals. The transaction module comprises one or more smart contracts generated for providing agreement between vendor and content creator, and enables payment transactions on approval of the smart contracts.

The database layer includes a blockchain database module and a cloud/on premise server module. The user personal information including name, phone number, address, state, country etc. is stored on their personal cloud/on premise server, thereby allowing the user to edit or update user personal information. The blockchain database is configured to store one or more data including UUID, type of user, duration and vendor ratings on the blocks, thereby executing one or more smart contracts.

Said layers in communication with each other, configured to evaluate strength of the bids and shortlisting bids of the vendors in an online trading platform, wherein the shortlisted bids are displayed/presented to the content creators, wherein the strength of the bids and shortlisting bids of the vendors is based on utilizing blockchain and a hashed universally unique identifier (UUID) authenticated vendor rating system, wherein the layers in the system is configured to assist in decision-making process for the content creators to decide on which bids to accept or decline, and analyze the bid based on one or more monetary aspects, one or more non-monetary aspects, location of the vendor and content creators or combination of all.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 is a user flow of the website browser in accordance with one embodiment of the invention.

FIG. 2 is a user flow of the vendor in accordance with one embodiment of the invention.

FIG. 3 is a user flow for deals between content creator and vendor in accordance with one embodiment of the invention.

FIG. 4 is a user flow of buyer in accordance with one embodiment of the invention.

FIG. 5 is a system architecture layer in accordance with one embodiment of the invention

FIG. 6 illustrates a functional mind map of the online trading platform, in an embodiment of the present invention.

FIG. 7 illustrates a user control flow for enrollment, in an embodiment of the present invention.

FIG. 8 illustrates a user control flow of individual classification, in an embodiment of the present invention.

FIG. 9 illustrates agreement/deals between content creator and vendor, in an embodiment of the present invention.

FIG. 10A and FIG. 10B is a process flowchart for the algorithm incorporated in the system, in an embodiment of the present invention.

FIG. 11A and FIG. 11B illustrates process flowchart for vendor and content creator functionality process, in an embodiment of the present invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

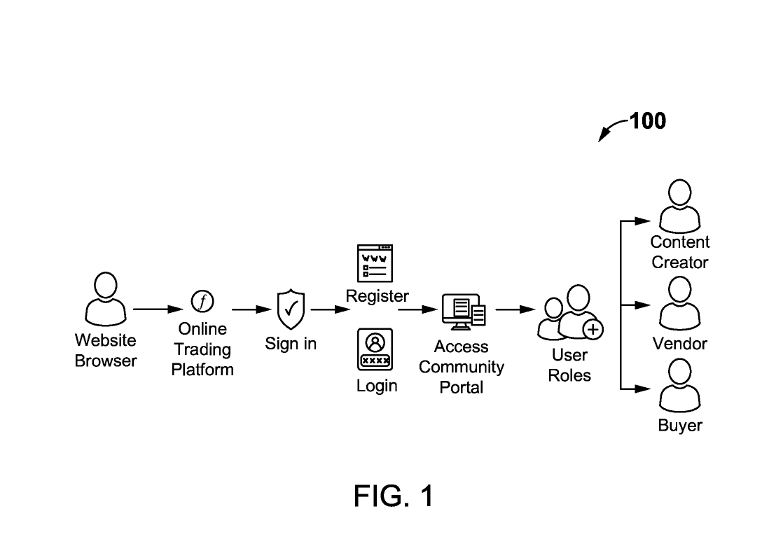

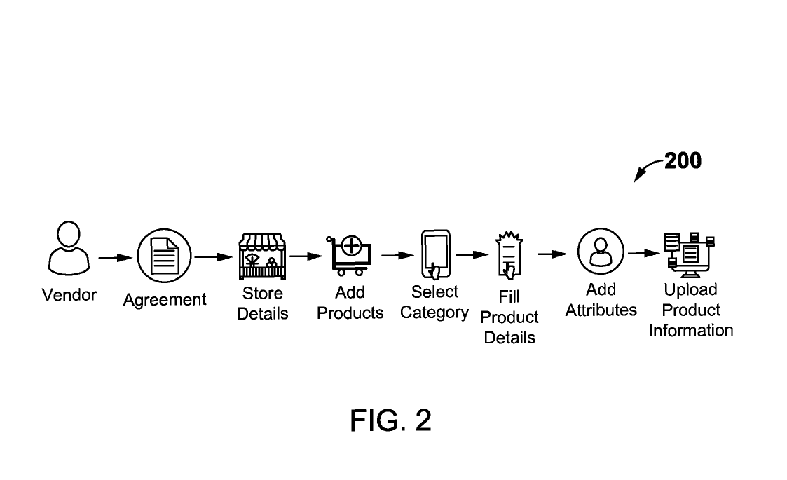

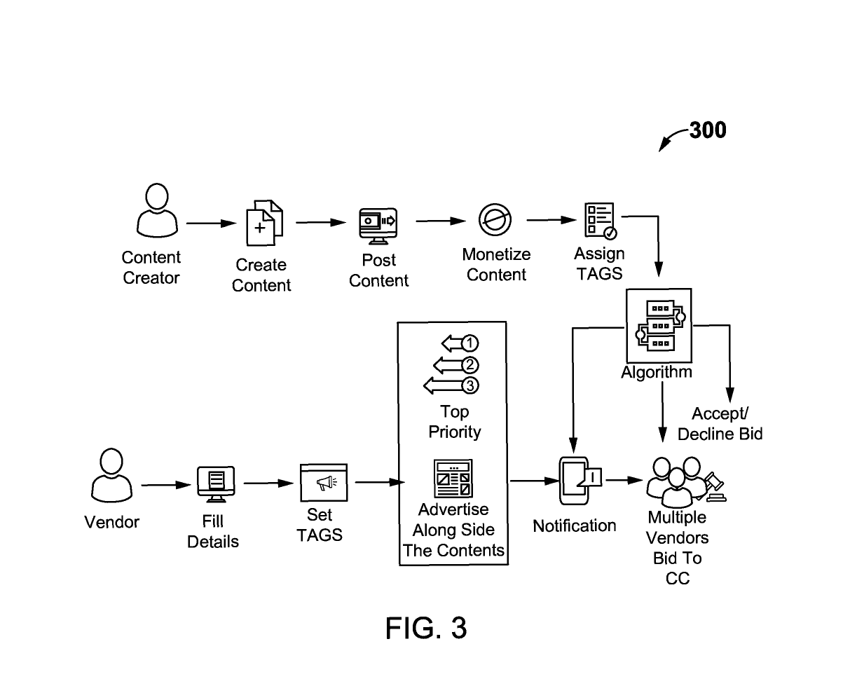

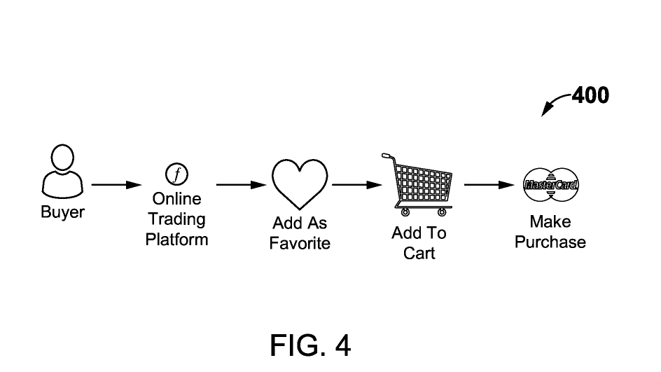

According to the present invention, system and method for blockchain based content monetization in an online trading platform is disclosed. The system is incorporated in an online platform which interlinks content with commerce section. Referring to FIG. 1-4, a user flow of the website browser 100, vendor 200, deals/agreement between content creator and vendor 300, and buyer 400, are illustrated. The platform consists of three sections-content section, commerce section and community section, respectively. Users are further divided into content creators (contributing to the content section), vendors and buyers (contributing to the commerce section) and website browser (contributing to the community section).

In one embodiment, the content section allows content creators to create content and to post that content to the open platform. The content platform has two types of users: content creators and content consumers. This section enables user to create their own content. All the content created by a content creator/user will be showcased in their own ‘Individual account page’. Individual account page stores and provides access to content creators to their content which they can then edit, save or delete as they wish. For creating such content, content creators can upload an image or video related to their content. Before posting this content, user can select his preference around sharing this content.

This community interface enables all the users (website browsers, sellers/vendors, buyers, content creators, and content consumers) to connect with each other. Anyone can browse the website without registering on it. However, if the user browsing the website want to make a purchase in the commerce section; and/or want to contribute content or save content to favorites in the content section; and/or want to connect with other members in the community section, they will be required to register to the website. Users/members who have signed up the platform, can interact, communicate and follow each other in this section.

Commerce section is an online marketplace. In this section, all the products, services, experiences and jobs are listed by independent vendors to create an online e-store within the system online commerce/trading platform and advertise their products and services for customers to buy. This section also has many other functionalities like marking any of the commerce category items as “favourite” for easy and quick access of customers. The Commerce platform/section also facilitates promotions of the products and services advertised in its categories via two ways: i) Vendors bidding for displaying their products and services on the first page or on top of the first page of search results to boost their visibility and sales, ii) traditional promotion system Pay Per Click (PPC) or Cost Per Click (CPC) is used. It is an online advertising model in which advertisers can display ads for their goods or services when users/customers searching for things online, by entering relevant queries into search engines.

Advertisers are only charged when a user clicks on their ad, hence the name “pay-per-click.” Vendors pays to the website to make their product visible. But these traditional approaches are not as efficient once website has millions of products to promote. Because of the dynamic nature of marketplace, multiple vendors want their product to be listed at top. Even if vendors pay more to the website to promote their products and services, it is not possible to keep their product and services advertisements at top every time as competitors attempt to outbid.

Along with traditional methods, a third innovative way of product and services promotion is, via advertising them alongside the content provided by content creators, allowing them to monetize their content via promoting products and services of the vendor. This method of promotion/content monetization concept is developed as an efficient solution to the existing gaps in the traditional promotion avenues, all while linking content and commerce sections and presenting an omni channel experience to the community members.

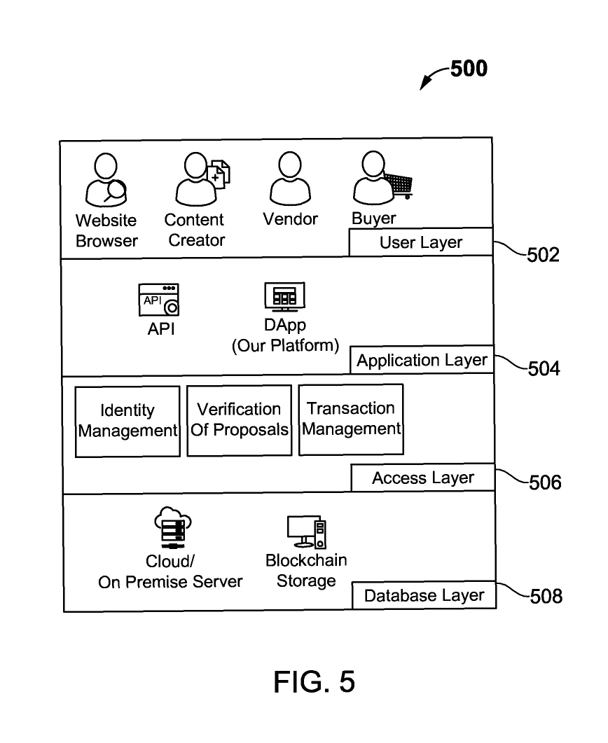

Referring to FIG. 5, a system architecture layer 500 in accordance with one embodiment of the invention, is illustrated. The system 500 comprises one or more layers or logical layers, such as a user layer 502, an application layer 504, an access layer 506 and a database layer 508. The system 500 comprises a user layer 502 including a website browser module, a content section module, a vendor module and a buyer module. In an embodiment, the website browser module is configured to allow one or more type of users on registering in the online trading platform. One or more users include a vendor, a buyer, a content creator, access a commerce portal/section, a content portal/section and a community portal or section. In one embodiment, the users are generated with a hash key, a pair of public key and private key. The generated public key is stored with the data on the blockchain and the private key is shared with the users. In one embodiment, the content section module enables content creators to create and post one or more contents in the platform. The content section module is configured to receive one or more biddings for one or more posted contents from the vendors. The vendor module enables one or more vendors to sell goods and services or create own e-store in the platform.

The vendor module enables one or more vendors to sell goods and services or create own e-store in the platform. If they want to endorse their products or services they can specify their requirements around it. These requirements include tags, which are given to each product by vendor, type of contents, category, number of followers of content creator etc. Buyers/consumer gives ratings to vendors for their products/services. For each vendor, average rating is calculated and these ratings constantly updates. Website browsers which make purchase from the platform can be considered as ‘Buyer’. Buyer can give ratings to the vendors based on the products/services they have received. By seeing these ratings, other buyers will consider these vendors for their next purchase. The generated UUID will be stored along with new column ‘Type’ (for example, B-Buyer, V-Vendor, C-Content creator) in blockchain database. As website browsers can be buyer, vendor or content creator as per their requirement.

In one embodiment, an application layer 504 includes a decentralized application and an application programming interface. The decentralized application (DApp) comprises two parts: User interface i.e front end application which is written in HTML, CSS, JavaScripts, and decentralized backend. The function which needs to be stored on blockchain, are written in smart contracts. DApp is similar application to other web applications. It deploys across several nodes rather than any central node. In one embodiment, API is set of defined methods of communication between various components. API layer consist of set of different scalable APIs—Blockchain API, Database API, Server API, APIs for frontend and APIs for smart contract, which is used for internal and external communication between the components. API request and response will be in JSON format.

In one embodiment, an access layer 506 is a smart contracts comprise one or more rules, business logic and conditions. Smart contracts are the piece of software which extends blockchain utility from simple record keeping of transactions to automatically implementing terms of multi-party agreements. Smart contracts are executed by computer network which uses consensus protocols. Smart contracts are generated for one or more agreement/terms between vendor and content creator, and payment/tokens is transferred to content creator once the agreement is fixed with the vendor. The access layer 506 include an identity management module, a verification of proposal module, and a transaction management module.

In one embodiment, the identity management module is configured to identify one or more users including website browser, content creators, vendors and buyers. In one embodiment, the verification of proposal module performs verification of vendors bidding by tag matching, and the tag matching is done by comparing tags defined by both vendor and content creator. The verification of proposal module performs rating classification based on a buyer rating on the vendors. The system further uses genuine vendor ratings as one of the input parameters to provide bid/proposal and overall value that enables the system to rank the bids in the order of 1 to n. Said bids are displayed to the content creator, where the system provides an option for the content creator to sort out predetermined number of bids or pre-selected bids, for example, the content creator may have received n=200 bids but the content creator opt to review only top 5 bids, so the algorithm incorporated in the system does the necessary calculations, ranks all the bids, and displays only those number of bids that the content creator nominates to review. The verification of proposal module performs filtration process by one or more parameters including location, acceptance ratio, or commission, to pre-process the proposals. In one embodiment, the transaction module comprises one or more smart contracts generated for providing agreement between vendor and content creator, and enables payment transactions on approval of the smart contracts.

In one embodiment, the system include a database layer 508, which includes a blockchain database module and a cloud/on premise server module. In one embodiment, the user personal information including name, phone number, address, state, country etc. is stored on their personal cloud/on premise server, thereby allowing the user to edit or update user personal information. In one embodiment, the blockchain database is configured to store one or more data including UUID, type of user, duration of advertisement cycle and vendor ratings on the blocks, thereby executing one or more smart contracts.

In one embodiment, said layers are communicatively coupled with each other, configured to evaluate strength of the bids and shortlisting bids of the vendors in an online trading platform. The shortlisted bids are displayed to the content creators. The strength of the bids and shortlisting bids of the vendors is based on utilizing blockchain and a hashed universally unique identifier (UUID) authenticated vendor rating system. In one embodiment, the layers in the system is configured to assist in decision-making process for the content creators to decide on which bids to accept or decline. The system according to an embodiment, further analyzes the bid based on one or more monetary aspects and one or more non-monetary aspects such as, location of the vendor and content creators.

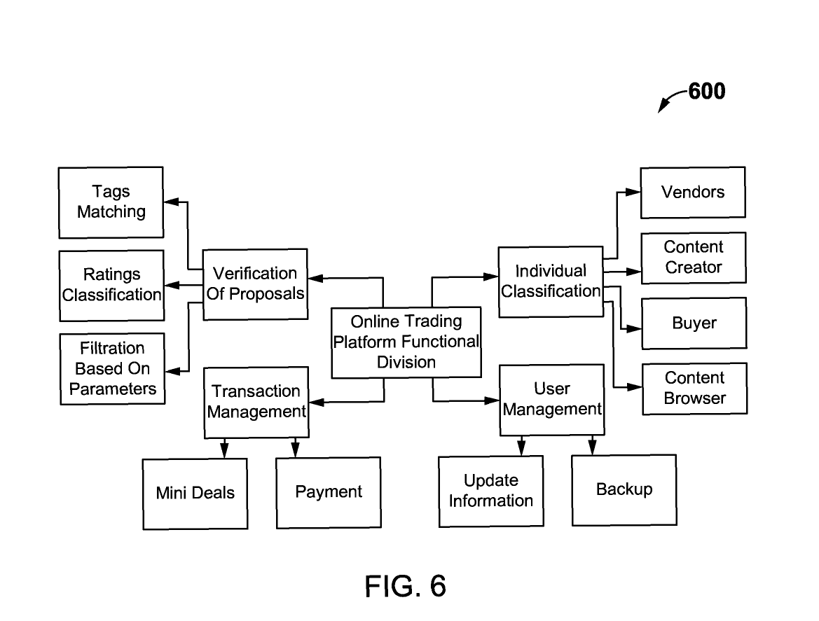

In one embodiment, the online trading platform 600 consists of the four primary functions, under which it comprises one or more sub functions, as shown in FIG. 6. The functions are broadly divided as: Individual classification, User management, Verification of proposals, and Transaction management. The individual classification function includes four sub functions under individual classification, website browser, content creator, vendor and buyer. For each of these sub functions, there are set of processes take place. For instance, the content creator sub function will have the following processes: Creation of content, Publish, Specify the requirements. Similarly, the sub functions for vendor comprises, fill out the store and product related details, advertise their products and define specifications of the product.

In user management module, the sub functions consists of, Update information, where the user can modify/edit his information at any time using DApp. Also, can add more details as per their requirement to the platform. Another sub function, Backup, where all the updated information, details shall be stored on the server.

In one embodiment, the verification of proposal consists of following sub function and processes, Tags matching, where the algorithm is responsible for comparing tags defined by both vendor and content creator. Rating classification, which as part of specification, ratings will be given to vendor from buyer. But content creator can specify their expected ratings for vendor. Based on this input, algorithm will classify vendors. Filtration, where other parameters like location, acceptance ratio, commission etc. will be used to further pre-processing the bid/proposals. In one embodiment, the transaction management sub functions are-agreement/deals between content creator and vendor, and payments.

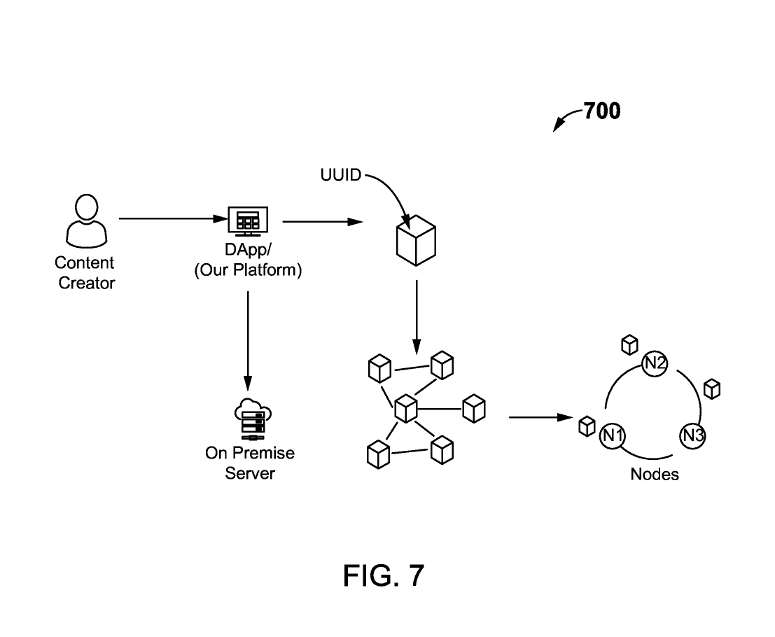

The user control flow 700 with the blockchain technology, is depicted in FIG. 7, Enrollment of the user as, to become a part of the online trading platform for selling the products, contributing the content to the platform, the website browser must register on the DApp/Platform. As a part of registration process, the user must fill out all the personal details which are needed. These details are stored on server. Once the registration is completed, Unique User ID (UUID)/Hash key is generated for every website browser. This transaction is then added to the block. Using blockchain for user ID verification, will assist in authentication of reviews as every user will be verified at the time of registration. The block is further added to the existing blockchain and gets broadcasted to the nodes.

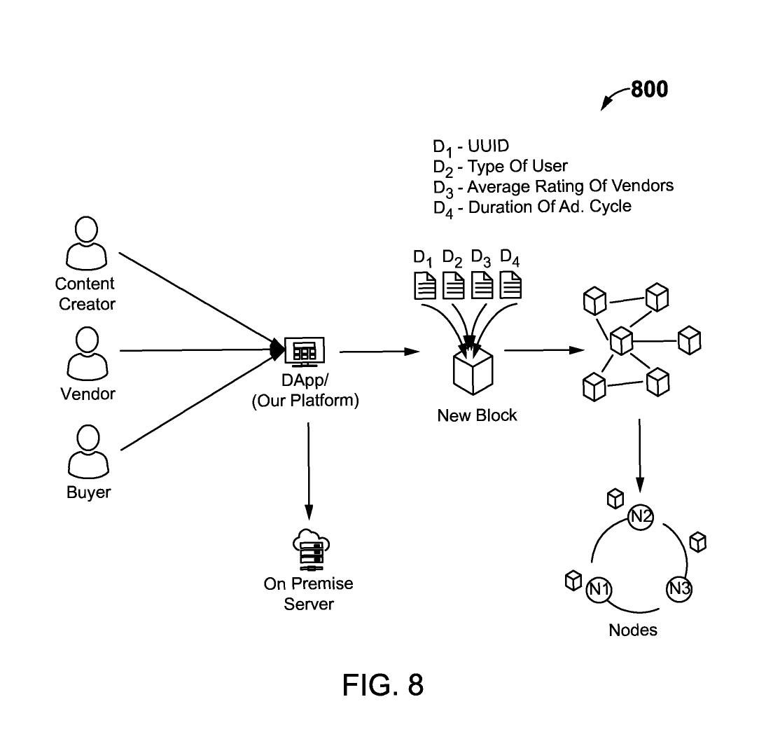

In FIG. 8, flowchart 800 on individual classification, is illustrated. When the website browser wants to perform some operation, the website browser needs to sign up with the platform. Depending upon this action, website browser is classified into three user roles as content creator, vendor and buyer. If the website browser wants to share their content with the platform, then their user role gets exchanged with the content creator. Same applies with Vendor if they want to sell their services on the platform and for Buyer as well if they want to make purchase through the platform. UUID, type of user (B, C, and V), ratings of vendors and duration of advertisement cycle are written on blocks. In blockchain, whenever the user want to update data, new block is used for every transaction. Further, this block is added to existing blockchain and distributed to all the nodes.

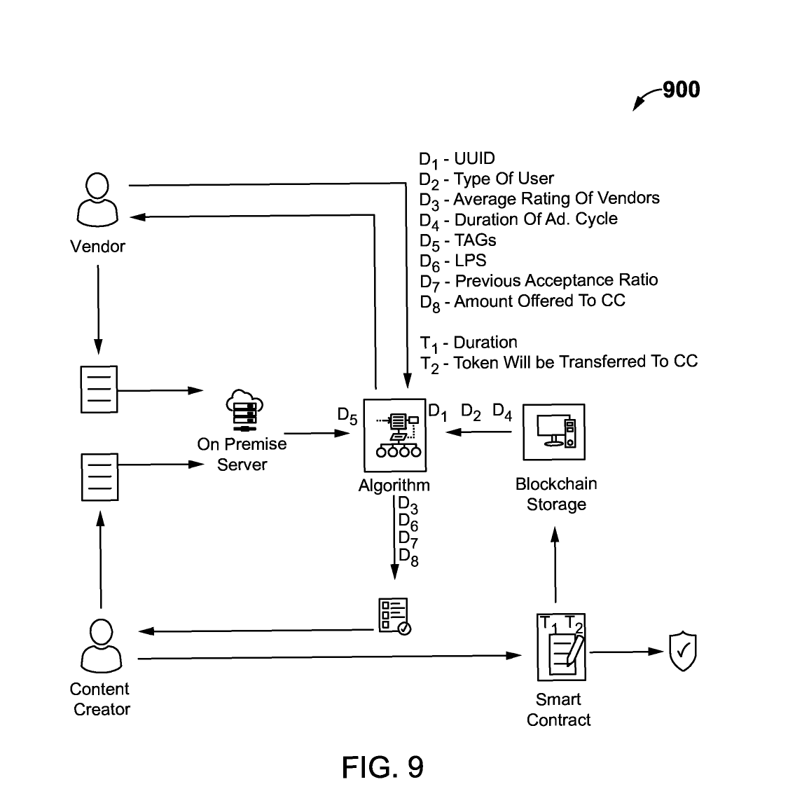

In deals/agreements between vendor and content creator, the designed algorithm plays significant role in the platform. All the parameters are monitored through this agreement. Flowchart 900 on how the deal/agreement is assigned to the content creator using blockchain is depicted in FIG. 9. If the vendor wants to promote their products or services, they must select the ‘endorsement’ option. After selection of this option, vendor needs to mention the specifications of those products. Same applies with content creators, if the content creator wants to monetize their content, they also need to fill out their requirements around product details.

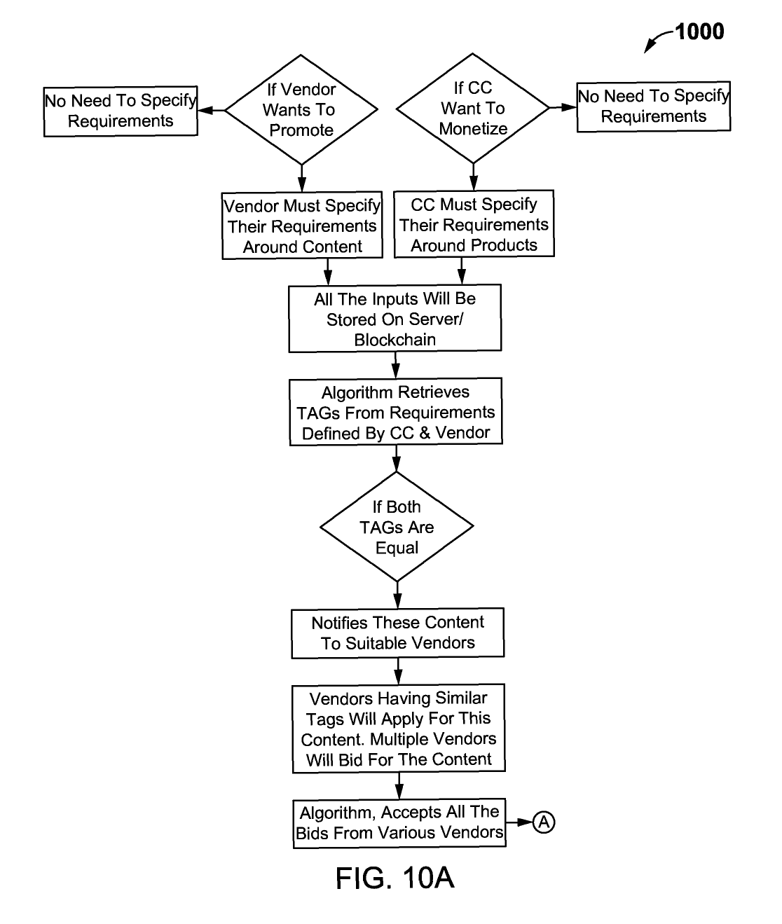

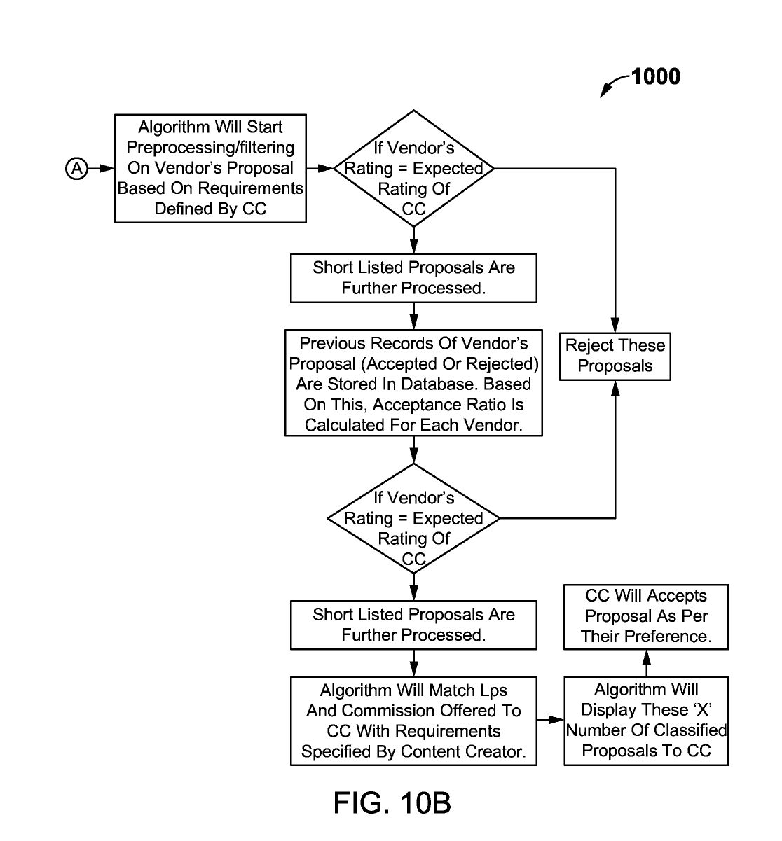

FIG. 10A and FIG. 10B is a process flowchart 1000 for the algorithm incorporated in the system, in an embodiment of the present invention. Specification input will be like-Type of content, Category, Number of followers, Vendor's ratings, TAGs, Number of proposals, Advertisement cycle, Commission, Locality of vendor and many more. All the specifications defined by content creator and vendor are stored in on-premise server and some specifications like ratings and duration of advertisement cycle are stored on blocks.

Algorithm fetches inputs from server and some from blockchain. Firstly, algorithm matches content creator's tags with vendor's tags. If the match is successful, then those content will be notified to vendors. According to the content displayed to vendors, applicable vendors bids for such content. For reference, if content creator's tags are about ‘Health’, ‘Nutrition’, ‘Diet food’ then all the vendors having equivalent products/services will respond for this content with their proposals. Suppose number of vendors who will apply to content is ‘N’. Now, other parameters like UUID, type of user, duration of advertisement cycle are fetched from blocks.

Further, the algorithm is responsible for filtering these proposals on the basis of other inputs like average ratings, LPS (locality preference score), previous acceptance ratio of vendors and amount offered to content creator (commission). All the filtered proposals, say ‘X’ proposals will be displayed to content creator. Final call is always given to content creator. Its up to content creator's choice, which proposal the user wants to accept. If vendor's proposal doesn't get accepted by content creator, then such vendor will not bid again for this content. The vendor will move on to the next content which is there in ecosystem. The vendor will bid again for other content and same procedure will repeat. This cycle will not stop until vendor's proposal gets accepted by any relative content creator.

Once the content creator selects proposal from ‘X’ number of proposal, smart contract will execute. Smart contract functions for following conditions: This smart contract will monitor the duration of advertisement cycle that means the contract/agreement between vendor and content creator will be valid for this time of duration. After acceptance of proposal, certain amount/tokens will be transferred to content creator's account. Smart contract always deploys on blockchain. When the specified duration gets over, it will trigger the user about it and agreement gets expired.

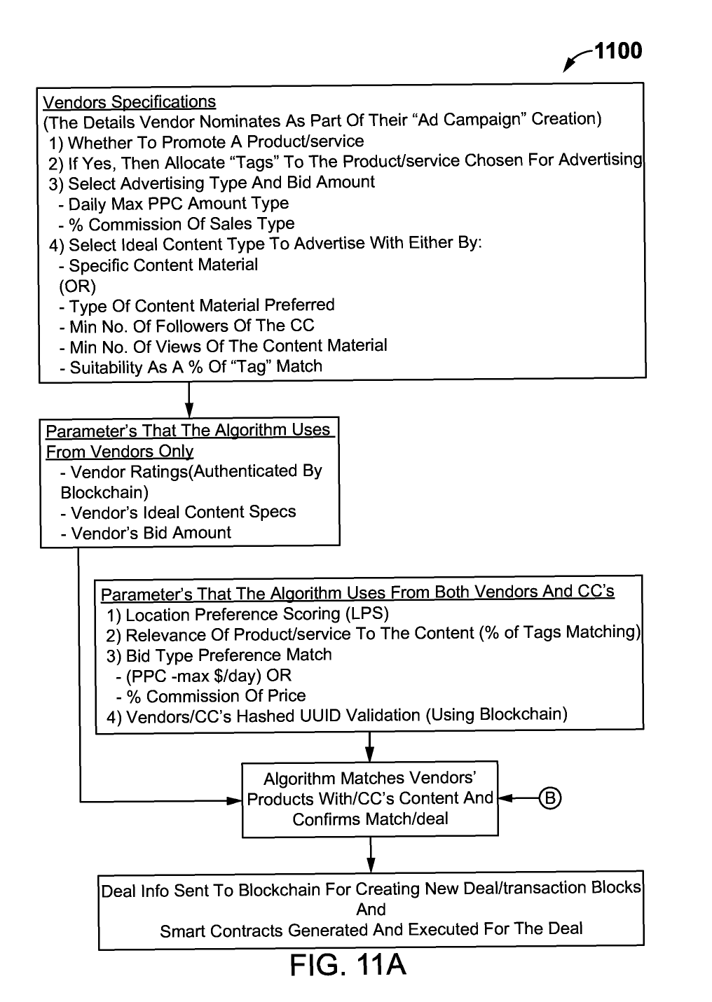

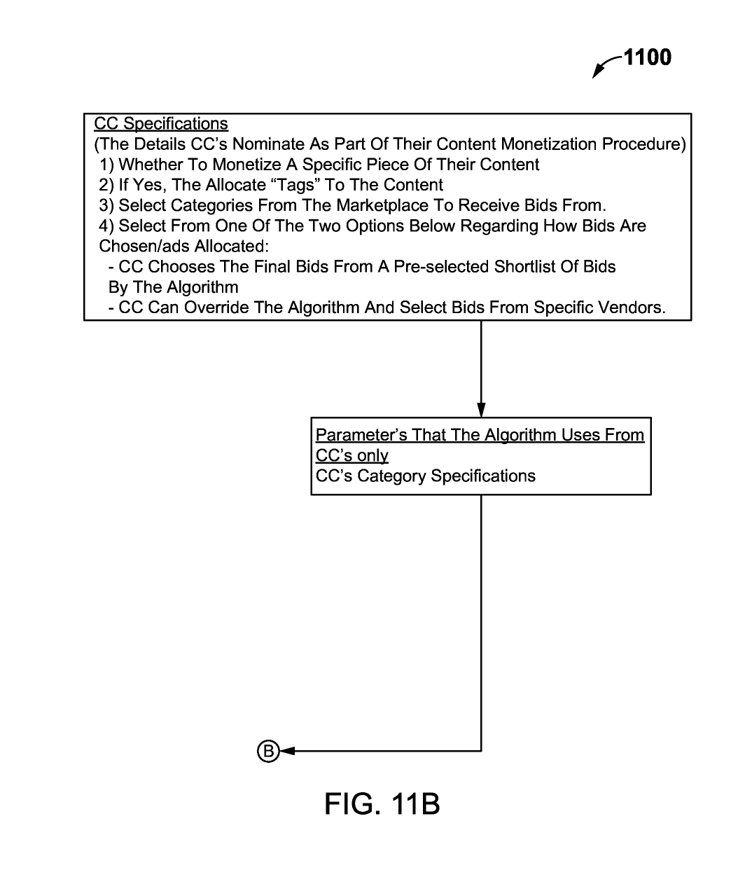

Referring to FIG. 11A and FIG. 11B, process flowchart 1110 for vendor and content creator functionality process with reference to FIG. 5, is illustrated. The present invention also discloses a computer implemented method for blockchain based content monetization in an online trading platform, according to an embodiment. The method comprises a user layer 502 including a website browser module, a content section module, a vendor module and a buyer module. In an embodiment, the website browser module is configured to allow one or more type of users on registering in the online trading platform. One or more users include a vendor, a buyer, a content creator, access a commerce portal, a content portal and a community portal. In one embodiment, the users are generated with a hash key, a pair of public key and private key. The generated public key is stored with the data on the blockchain and the private key is shared with the users. In one embodiment, the content section module enables content creators to create and post one or more contents in the platform. The content section module is configured to receive one or more biddings for one or more posted contents from the vendors. The vendor module enables one or more vendors to sell goods and services or create own e-store in the platform.

In one embodiment, an application layer 504 includes a decentralized application and an application programming interface. In one embodiment, an access layer 506 is a smart contracts comprise one or more rules, business logic and conditions. The access layer 506 include an identity management module, a verification of proposal module, and a transaction management module. In one embodiment, the method include a database layer 508, which includes a blockchain database module and a cloud/on premise server module.

In one embodiment, said layers are communicatively coupled with each other, the layers communicatively coupled with each other, configured to perform the steps of, evaluating strength of the bids and shortlisting bids of the vendors in an online trading platform, wherein the shortlisted bids are displayed to the content creators. The strength of the bids and shortlisting bids of the vendors is based on utilizing blockchain and a hashed universally unique identifier (UUID) authenticated vendor rating system. In another step, the method comprises, assisting in decision-making process for the content creators to decide on which bids to accept or decline. In another step, the method includes, analyzing the bid based on one or more monetary aspects and one or more non-monetary aspects such as, location of the vendor and content creators.

The advantage of the disclosed system incorporated with blockchain technology, helps all the users on blockchain have full record of every transactions. Whenever a new transaction is written on platform, the copy of this transaction will be replicated to all the systems. So, it is impossible to forge transactions or modify transactions. So, because of blockchain, vendors cannot post fake reviews and only one review can be given by the buyer for their products and services which is genuine, and easily trackable. If such false transaction occurs, the users will find inconsistencies in their full ledger and will reject that. Such an ecosystem will help the online trading platform to achieve maximum level of transparency.

In terms of security, the blockchain is a distributed ledger system that uses a network consensus to record and execute transactions. No single agent has the ability to execute control over system activity. Once the transaction is written, it is immutable and can never be altered. If user wants to modify the transaction, new block will be used for this transaction. Blockchain stores all the transactions in chronological manner. Further, the decentralized ecosystem could not be tampered with using a single node. To bring the entire the network down, more than 50% systems in network will have to be hacked in real time, which is next to impossible. This will make the platform and data invulnerable to cyber-attacks.

As traditional systems use few dedicated servers to support the network, this poses a limitation in increasing scalability of network. So, instead of using dedicated servers, the power of all the systems/nodes in entire network will be utilized. This will increase in the capacity of the platform. Since there will be no middle man involved in the monetarization of process, only minimal amount of gas usage will be charged as convenience fees. In blockchain, the term “Gas” is used for measuring how much ‘work’ an action or set of actions takes to perform. Every operation that can be performed by a transaction or contract on the blockchain platform costs a certain number of gas, with operations that require more computational resources costing more gas than operations that require few computational resources. It helps to ensure an appropriate fee is being paid by transactions submitted to the network. Since all the transaction and contracts will be made without any intervention of third party, all the deals between content creator and vendor will be settle in real time.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

1-20. (canceled)

21. An online trading platform system housed on one or more servers and/or nodes, the platform comprising multiple interactive layers, wherein the multiple layers include:
a user layer configured to communicate with one or more users and configured to identify each user as a website browser, a vendor, a buyer, or a content creator, the user layer comprising:
a website browser module configured so that a user identified as a website browser can browse the online trading platform,
a content section module configured so that a user identified as a content creator can create and post one or more contents in the online trading platform, wherein the content section module is also configured to receive one or more proposals for one or more posted contents from a user identified as a vendor,
a vendor module configured so that a user identified as a vendor can sell goods or services in the online trading platform and can make proposals to a content creator,
a buyer module configured so that a user identified as a buyer can make purchases from the online trading platform, the buyer module also configured so that a buyer can rate a vendor for their goods or services, wherein the buyer module affects a transaction between a vendor and a content creator;
an application layer comprising a decentralized application and an application programming interface, wherein the decentralized application comprises a user interface and a decentralized backend deployed across multiple nodes, and wherein the application programming interface is a set of application programming interfaces that enable the other layers to communicate with the application layer;
an access layer comprising an identity management module that includes software configured to identify a user, a verification of proposal module that includes software configured to verify vendors proposals, and a transaction management module that includes software configured to provide agreements between vendors and content creators and that enables payment transactions; and
a database layer comprising a blockchain database module and a server module, wherein the blockchain database module is configured to store a universally unique identifier associated with each user and a rating for each vendor, and wherein the server module is configured to store personal information about each user including location data,
wherein each of the layers communicate with one another so that (i) multiple proposals from vendors for a post by a content creator can be filtered on the basis of multiple parameters, (ii) the filtered proposals can be displayed to the content creator, and (iii) one of the filtered proposals can be selected by the content creator, wherein the multiple parameters include the blockchain-stored vendor rating, one or more monetary aspects, one or more non-monetary aspects, and location data for the vendor and the content creator.

22. The online trading platform system of claim 21, wherein the one or more monetary aspects includes the commission the vendor is offering to the content creator.

23. The online trading platform system of claim 21, wherein the one or more non-monetary aspects includes one or more of a previous acceptance ratio of the vendor, the relevance of the vendor's product or service to the content created based on tags, and the duration of an advertisement nominated by the vendor and the content creator.

24. The online trading platform system of claim 21, wherein layers communicate with one another so that when a proposal is selected by the content creator, the online trading platform system is configured to execute a smart.

25. The online trading platform system of claim 24, wherein the smart contract will monitor the duration of an advertising cycle and will transfer monetary amounts to the content creator.

26. The online trading platform system of claim 25, wherein the smart contract is deployed on blockchain.

27. The online trading platform system of claim 21, wherein the application programming interface comprises a blockchain application programming interface, a database application programming interface, and an application programming interface for contracts, and wherein the application programming interfaces are incorporated for internal and external communication between the layers.

28. The online trading platform system of claim 21, wherein the verification of proposal module is configured to perform verification of vendors proposals by comparing tags defined by both vendor and content creator.

29. The online trading platform system of claim 21, wherein the server module is configured to store personal information of a user including name, phone number, and address, and wherein the user is allowed to edit or update their user personal information.

30. The online trading platform system of claim 21, wherein the verification of proposal module classifies vendor ratings based on buyer ratings for the vendors.

31. A computer-implemented method for blockchain based content monetization in an online trading platform, the method comprising:
communicating with one or more users and identifying each user as a website browser, a vendor, a buyer, or a content creator, wherein:
a user identified as a website browser is allowed to browse the online trading platform,
a user identified as a content creator is allowed to create and post one or more contents in the online trading platform and the content creator is allowed to receive one or more proposals for one or more posted contents from a user identified as a vendor,
a user identified as a vendor is allowed to sell goods or services in the online trading platform and to make proposals to a content creator,
a user identified as a buyer is allowed to make purchases from the online trading platform, the buyer is also allowed to rate a vendor for their goods or services and wherein the buyer can affect a transaction between a vendor and a content creator;
providing a decentralized application and an application programming interface, wherein the decentralized application comprises a user interface and a decentralized backend deployed across multiple nodes, and wherein the application programming interface is a set of application programming interfaces;
providing an access layer comprising an identity management module that includes software capable of identifying and classifying a user, a verification of proposal module that includes software capable of performing verification of vendors proposals, and a transaction management module that includes software capable of providing agreements between vendors and content creators and that enables payment transactions;
providing a database layer comprising a blockchain database module and a server module, wherein the blockchain database module is configured to store a universally unique identifier associated with each user and a rating for each vendor, and wherein the server module is configured to store personal information about each user including location data;
filtering multiple proposals from vendors for a post by a content creator on the basis of multiple parameters, the multiple parameters include the blockchain-stored vendor rating, one or more monetary aspects, one or more non-monetary aspects, and location data for the vendor and the content creator; and
displaying the filtered proposals to the content creator,
whereby the content creator can select one of the filtered proposals.

32. The method of claim 31, wherein the one or more monetary aspects includes the commission the vendor is offering to the content creator.

33. The method of claim 31, wherein the one or more non-monetary aspects includes a previous acceptance ratio of the vendor, the relevance of the vendor's product or service to the content created, and the duration of an advertisement nominated by the vendor and the content creator.

34. The method of claim 31, further comprising executing a smart contract when a proposal is selected by the content creator.

35. The method of claim 34, wherein the smart contract will monitor the duration of an advertising cycle and will transfer monetary amounts to the content creator.

36. The method of claim 35, wherein the smart contract is deployed on blockchain.

37. The method of claim 31, wherein the application programming interface comprises a blockchain application programming interface, a database application programming interface, and an application programming interface for contracts.

38. The method of claim 31, wherein the verification of proposal module performs verification of vendors proposals by comparing tags defined by both vendor and content creator.

39. The method of claim 31, wherein the server module stores personal information of a user including name, phone number, and address, and wherein the user is allowed to edit or update their user personal information.

40. The method of claim 31, wherein a single user can be identified as more than one type of user.

41. The method of claim 31, wherein a user identified as a website browser is allowed to browse the online trading platform, communicate with other users, and comment on or like content.
